(19) United States
(12) Patent Application Publication
(10) Pub. No.: US 2009/0113950 A1
(43) Pub. Date: May 7, 2009

(54) Lock structure

(76) Inventor: Wen-Kwei Chang, Changjhih Township (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/979,652

(22) Filed: Nov. 7, 2007

(51) Int. Cl. E05B 67/00; E05B 67/38

(52) U.S. Cl. 70/54; 70/51

(57) ABSTRACT

A lock includes a lock body, which has a core holding hole in a middle portion, and a lock core fitted in the core holding hole; the lock body has several pin holes on a periphery portion thereof; saw-resistant pins are inserted in the pin holes of the lock body respectively to protect the lock body from being damaged with tools such as a saw; the saw-resistant pins have already undergone heat treatment so as to have increased strength.

### BACKGROUND OF THE INVENTION

1. Field of the Invention

The present invention relates to an improvement on a lock structure, more particularly one, which consists of a lock body, and several saw-resistant pins inserted in a periphery portion of the lock body to prevent the lock body from being damaged with a saw.

2. Brief Description of the Prior Art

A variety of locks are available for helping to prevent thievery, e.g. door locks, combination locks, and cable locks, which are mainly used for locking bicycles and motorcycles. And, the industry have recently developed electromagnetic locks, chip locks, and voice-controlled locks, which are more advanced than conventional locks, and can't be easily open by unauthorized persons. Moreover, stronger locks are also available, which are made of saw-resistant materials so as not to be damaged with saws.

Shown in FIG. 6 is a kind of currently existing stacked-plates lock 8. The lock 8 includes a lock body consisting of several metallic plates 81, which have already undergone heat treatment to have increased strength, and are positioned on above another. Therefore, it is relatively difficult for thieves to damage the lock 8 with a saw.

However, it takes relatively much cost, labor and time to manufacture the lock 8 because all of the metallic plates 81 have to be subjected to heat treatment, and then stacked and fastened together by means of rivets.

### SUMMARY OF THE INVENTION

It is a main object of the present invention to provide an improvement on a lock structure, which has relatively good saw-resistant capability, and takes relatively little cost, labor and time to manufacture, to overcome the above problems.

A lock according to an embodiment of the present invention includes a lock body, which has a core holding hole in a middle portion, and a lock core fitted in the core holding hole. The lock body has several pin holes on a periphery portion thereof, and saw-resistant pins are inserted in the pin holes of the lock body respectively; the saw-resistant pins have already undergone heat treatment to have high strength therefore they will protect the lock body from being damaged with saws.

### BRIEF DESCRIPTION OF THE DRAWINGS

The present invention will be better understood by referring to the accompanying drawings, wherein:

FIG. 1 is an exploded perspective view of the present invention,

FIG. 2 is a perspective view of the present invention,

FIG. 3 is a lateral sectional view of the present invention (1),

FIG. 4 is a lateral sectional view of the present invention (2),

FIG. 5 is a horizontal sectional view of the present invention, and

FIG. 6 is an exploded perspective view of the prior art.

### DETAILED DESCRIPTION OF THE PREFERRED EMBODIMENTS

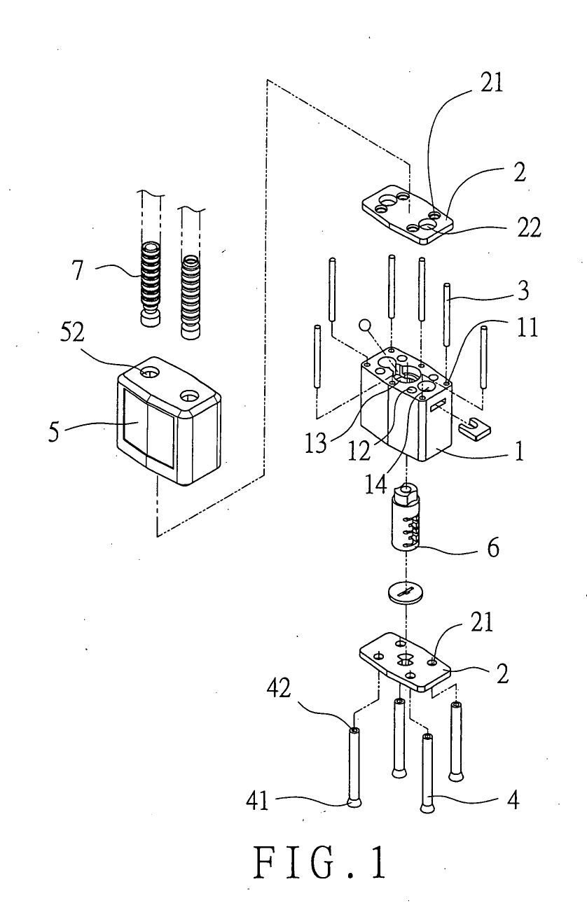

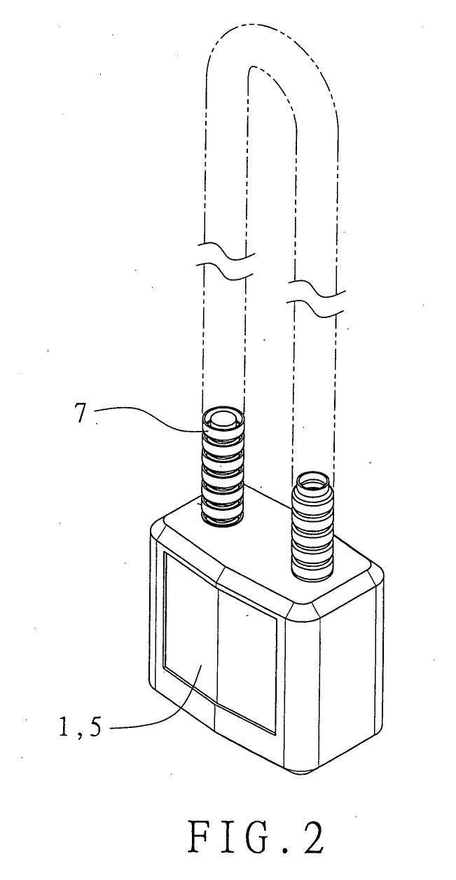

Referring to FIG. 1, a preferred embodiment of a lock structure of the present invention includes a lock body 1, upper and lower covering plates 2, several saw-resistant pins 3 to prevent the lock body 1 from being sawn through, several fixing pins 4, and a shell 5.

The lock body 1 is made of hard plastics, and has several pin holes 11 spaced apart on a periphery thereof. The saw-resistant pins 3 have already undergone heat treatment to increase in strength, and are inserted in the pin holes 11 of the lock body 1 respectively to prevent the lock body 1 from being cut with a saw; because the saw-resistant pins 3 have already undergone heat treatment, they are stronger than common saws; the pin holes 11 have a smaller diameter than the saw-resistant pins 3 therefore the saw-resistant pins 3 are tight in the pin holes 11. The lock body 1 further has several fixing holes 12 next to the pin holes 11, a core holding hole 13 in a middle, and lock holes 14 on two sides of the core receiving hole 13. And, the lock body 1 is equipped with a lock core 6, which is held in the core holding hole 13 thereof.

A cable 7 is securely joined to a first one of the lock holes 14 of the lock body 1 at a first end, and can be passed at a second end thereof into the other (second) lock hole 14 to be fastened to the lock body 1 by means of the lock core 6; the second end of the cable 7 can be separated from the lock hole 14 after the lock core 6 is moved to an unlocking position.

The cable 7 is taught in a patent application, “SAW AND SCISSOR RESISTANT STRUCTURE OF A CABLE LOCK”, by the inventor of the present invention, which cable lock includes a lock body, and a cable component; the lock body has a fixing hole, and a detainment hole on a top; the cable component is inserted in and securely joined to the fixing hole of the lock body at a first end, and it can be passed at a second end thereof into the detainment hole to be fastened to the lock body; the lock body can be moved to an unlocking configuration by means of a key, thus allowing the second end of the cable component to separate from the detainment hole. The cable component includes a flexible cable, and several metallic rings positioned around the flexible cable. The metallic rings can be made of extra-strong and steel materials or metallic materials having already undergone a special strengthening treatment. A first end of each metallic ring has a smaller outer diameter than a second end of the metallic ring; the smaller first end of the metallic ring is substantially cone-shaped, becoming gradually narrower towards a free end thereof, and the free end has a spherical surface. The larger second end of each metallic ring is substantially bell-shaped, becoming gradually wider towards a free end thereof; the metallic rings are positioned close together such that the spherical surface and the conical portion of the smaller first end of one said metallic ring is received in the bell-shaped second end of an adjacent metallic ring. Thus, the cable component can't be damaged with saws or scissors.

The upper and the lower covering plates 2 each have several fixing holes 21 thereon. The upper covering plate 2 further has two through holes 22 to face the lock holes 14 of the lock body 1. The upper and the lower covering plates 2 are positioned on a top and a bottom of the lock body 1 respectively, with the fixing holes 21 thereof facing corresponding said fixing holes 12 of the lock body 1.

The fixing pins 4 have already undergone heat treatment, and are inserted in the fixing holes 21 of the lower covering plate 2, the fixing holes 12 of the lock body 1, and the fixing holes 21 of the upper covering plate 2 so as to fasten the lock body 1 and the upper and the lower covering plates 2 together. Each of the fixing pins 4 has a stopping bottom portion 41 with a truncated-cone shape, and a riveting hole 42 on the upper end; the upper ends of the fixing pins 4 are pressed/hammered to open so as to be firmly fixed in position; the stopping bottom portions 41 of the fixing pins 4 are stopped from moving into the fixing holes 21 of the lower covering plate 2, thus being pressed against the bottom side of the lower covering plate 2. Furthermore, the fixing holes 12 of the lock body 1 have a smaller diameter than the fixing pins 4.

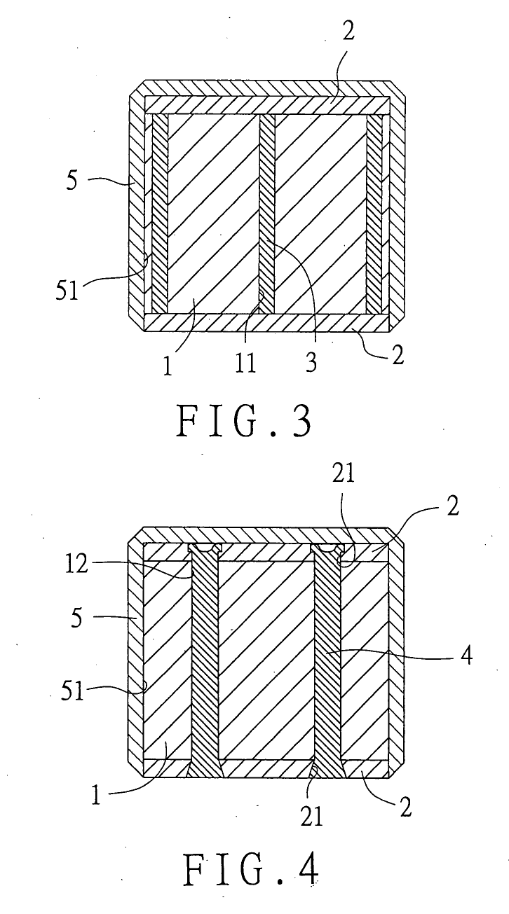

The shell 5 has a receiving hole 51 as shown in FIG. 3, and the lock body 1 is firmly fixed in the receiving hole 51. The shell 5 further has two through holes 52 to face the lock holes 14 of the lock body 1 respectively.

In assembly, first the saw-resistant pins 3 are inserted in the pin holes 11 of the lock body 1 to prevent the lock body 1 from being sawn. Next, the lock core 6 is positioned in the core holding hole 13. The upper and the lower covering plates 2 are positioned on the top and the bottom of the lock body 1, and the fixing pins 4 are inserted in the fixing holes 21 and 12 with the stopping bottom portions 41 being pressed against the bottom of the lower covering plate 2, and with the upper ends sticking out from the upper covering plate 2. Then, the upper ends of the fixing pins 4, on which the riveting holes 42 are formed, are subjected to pressure to open so as to fasten the lock body 1 and the covering plates 2 together, as shown in FIG. 4. Finally, the cable 7 is securely joined to one of the lock holes 14 of the lock body 1 at the first end, and the shell 5 is positioned over the lock body 1.

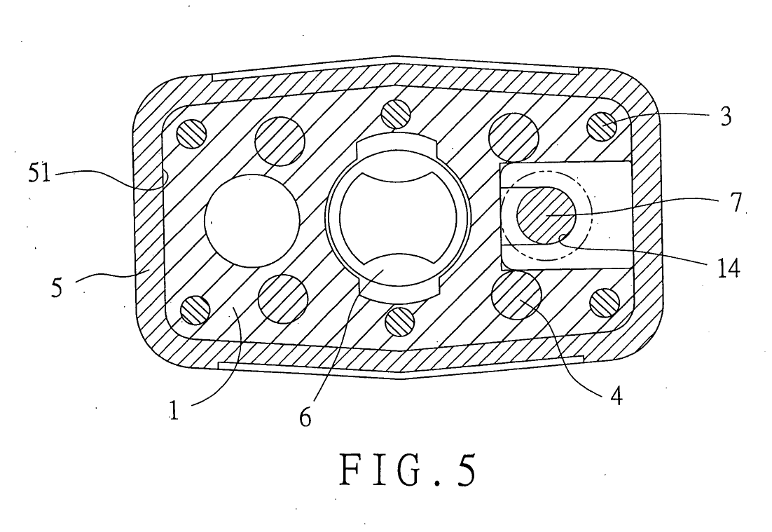

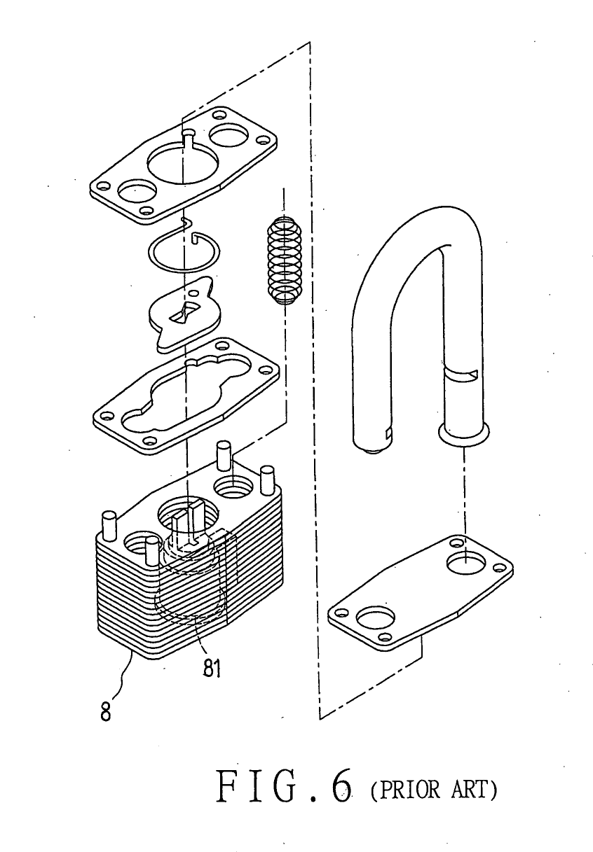

In use, the cable 7 is passed through an object, and next the second end of the cable 7 is passed into the second lock hole 14 of the lock body 1, and fastened with the lock core 6, as shown in FIG. 5; thus, if a thief tries to damage the lock by means of a tool such as a saw, the tool will be stopped by the saw-resistant pins 3 inserted in the periphery portion of the lock body 1.

From the above description, it can be seen that the present invention has the following advantages:

1. The lock body of the present invention is protected against sawing by means of the saw-resistant pins, which are inserted in the periphery portion, and have already undergone heat treatment. Therefore, while having the same saw-resistant capability, the present lock body has relatively low manufacturing cost as compared with the prior art, which comprises several stacked metallic plates having already undergone heat treatment.

2. The present lock body is protected against sawing by means of the saw-resistant pins, which are inserted in the periphery portion, and have already undergone heat treatment. Therefore, while having the same saw-resistant capability, the present lock body takes less labor and time to assemble than the prior art, which comprises several stacked metallic plates having already undergone heat treatment.

3. The fixing pins also can be subjected to heat treatment to help increase the saw-resistant capability of the lock body before they are used to fasten the lock body and the covering plates together.

4. The cable of the present invention can be subjected to special strengthening treatment to have saw-resistant capability so that the whole lock can prevent thievery effectively.

What is claimed is:

1. A lock structure, comprising
a lock body, the lock body having a plurality of pin holes on a periphery thereof; the lock body having a core holding hole in a middle, in which a lock core is held; and
a plurality of saw-resistant pins with high strength inserted in the pin holes of the lock body.

2. The lock structure as claimed in claim 1 further comprising covering plates secured on upper and lower sides of the lock body; the lock body having a plurality of fixing holes next to the pin holes; the covering plates having a plurality of fixing holes to face the fixing holes of the lock body; the covering plates being joined to the lock body by means of fixing pins, which are inserted in the fixing holes of the covering plates and the lock body.

3. The lock structure as claimed in claim 2, wherein each of the fixing pins has at one end thereof a stopping portion with a truncated cone shape, and has a riveting hole at other end thereof.

4. The lock structure as claimed in claim 3, wherein the fixing pins are subjected to heat treatment.

5. The lock structure as claimed in claim 1 further comprising a shell positioned over the lock body; the shell having a receiving hole to hold the lock body.

6. The lock structure as claimed in claim 1 further comprising a cable joined to the lock body; the lock body having lock holes on two sides of the core holding hole; the cable being securely joined to one of the lock holes at one end thereof; other end of the cable being capable of being inserted in other one of the lock holes in a movable manner.

7. The lock structure as claimed in claim 1, wherein the saw-resistant pins are subjected to heat treatment.

8. The lock structure as claimed in claim 1, wherein the lock body is made of hard plastics.
